(19) United States
(12) Patent Application Publication
(10) Pub. No.: US 2019/0227510 A1
(43) Pub. Date: Jul. 25, 2019

(54) APPARATUS, SYSTEM AND METHODS FOR DIGITAL DISPLAY MONITORING AND REPORTING

(71) Applicant: William Hoggatt, Chicago, IL (US)

(72) Inventor: William Hoggatt, Chicago, IL (US)

(21) Appl. No.: 15/878,218

(22) Filed: Jan. 23, 2018

(51) Int. Cl. G05B 19/048; G06F 11/30; G06Q 30/02; H04N 7/18; G09F 19/00

(52) U.S. Cl. CPC G05B 19/048; G06F 11/3058; G06F 11/3075; G09F 19/00; G06F 11/3013; H04N 7/188; G06Q 30/0272

(57) ABSTRACT

A monitoring, alerting and reporting system and methods for recording and monitoring specific portions of static and digital displays and display panels, such as billboards, by recording the display using multiple cameras and providing remote monitoring, operational reporting and alerts, along with POP services, which include a web-based or application-based monitoring, alerting and reporting system. For accuracy purposes, the system relies on a camera to record the actual advertisement or message being displayed on the billboard, while a second camera is used to record a unique identification code or mark pertaining to the particular advertisement being displayed, whether the advertisement is an image, a video or even text. By recording both the actual video and the identification code, the system can accurately monitor and report on the various advertisements being displayed, including the time and length of display.

The present application is a continuation of and claims priority to U.S. Provisional Patent Application Ser. No. 64/449,229, filed Jan. 23, 2017, and entitled “Apparatus, System And Methods For Digital Display Monitoring And Reporting”, which is hereby incorporated by reference in its entirety.

### BACKGROUND

### a. Technical Field

The present disclosure relates to an apparatus, system and methods for the monitoring of and reporting on digital displays, and in particular, the present disclosure is for an apparatus, system and related methods for monitoring static and digital displays and display panels, such as billboards and signs, by recording both the display and an identification mark, and providing to operators and users remote monitoring, operational reporting and alerts, along with proof of performance (POP) services, all through a web-based or application-based monitoring, alerting and reporting system.

The present disclosure relates to a POP system that is separate and independent from the digital display's internal media player and can be used to prove that particular content was actually displayed on the screen, not just that a signal ostensibly displayed content on the screen. To do so, the present disclosure incorporates a digital display monitoring system featuring a two camera system and a control box. The two cameras are housed in housing designs that can be attached easily to the billboard, screen or monitor frame to obtain actual video of screen content as it is displayed.

### b. Background of Disclosure

A billboard is a large structure that displays an advertisement, and is typically found alongside highways and other high-traffic areas. Based on their locations, billboards provide advertisement information to those passing pedestrians and drivers. The more people that see the billboard, the more successful the advertisement will be, therefore billboards are usually located in highly visible areas and attempt to use distinctive and highly memorable visuals.

Billboards have been around for many years and roadside billboards have become ubiquitous to stories of automobile travel. Some billboards have become famous in the way they were used, such as the Burma Shave billboards, placed along the road such that when a passenger in the passing car read them in order of the direction of travel, they made up a single advertising idea. For example, six red Burma-Shave signs with white letters placed a distance apart from each other alongside the road; the first sign reading “your shaving brush”, the second sign reading “has had its day”, the third sign “so why not”, the fourth sign “shave the modern way”, the fifth “with” and finally the last sign read “Burma-Shave.”

The largest billboards are usually located on major highways, expressways or principal roadways, and command high-density consumer exposure. The largest billboards afford the greatest visibility due to their size, and usually to their creative content. Posters, on the other hand, are another form of billboard advertising. Posters are located mostly along primary and secondary arterial roads, and are a smaller format than the large billboards.

More recently, electronic or digital billboards have begun to replace standard billboards. A digital billboard is a billboard that is created from computer programs and software, and the message is displayed digitally on the screen. Digital billboards can be designed to display pictures and text like a standard billboard, but it can also display running text and video. The digital display can also change quickly to display several different advertisements from the same company, or provide advertisements or messages from different companies at certain time slots during the day. The constantly changing pictures, video and text provide maximum advertising impact and a wide exposure to target audiences.

With the digital billboard and the capability to change the message at various times during the day or night, there developed a need for the digital billboard to be monitored to make sure that the billboard was working and providing the advertisement paid for at the correct times during the day and night. Current digital billboard monitoring systems monitor the digital billboard control system to monitor the content of the billboard to be displayed. This system does not account for problems between the control system and the actual display of the content. Problems that occur during the display of the content may go undetected.

Current digital billboard monitoring systems also monitor the digital billboard by using a camera to record the actual picture or video on the display. In some cases, the camera has a 180 degree or fisheye lens to record some or all of the billboard display. The recorded information can be sent to a control system that can report on the information provided.

As an example, U.S. Pat. No. 8,248,203, titled Remote Monitor/Control For Billboard Lighting Or Standby Power System (“the '203 patent”), discloses a lighting monitor and control system for remote billboards. The '203 patent uses a cellular network to provide utility power and light status information to a central controller, which in response provides control signals to individual remote billboard lighting controllers for setting operating parameters such as multiple on/off times, lighting power adjustments for individual billboards, and custom lighting schedules based upon geographic and environmental considerations.

Another example, U.S. Pat. No. 8,441,574, titled Visual Identifier For Images On An Electronic Display (“the '574 patent”), discloses a light sensor placed in front of an electronic display to monitor actual display performance. The '574 patent discloses displaying images or video on an electronic display. A unique identifier may be embedded within the frames of images or video and detected by a light sensor. The data from the light sensor is analyzed to determine if the proper image or video was actually shown at the display. Some embodiments analyze the data from the light sensor in real time and may stop displaying the image or video if the data is not in the format of a unique identifier. Using his embodiment, the system can prevent unintended images or video from being shown on the display.

As such there is a need for an apparatus and system for monitoring static and digital displays and display panels, such as billboards, by recording the display, providing remote monitoring, operational reporting and alerts, along with proof of performance (POP) services, for operators, including a web-based or application-based monitoring, alerting and reporting system. There is also a need for a process or methods for monitoring digital billboards, and providing remote monitoring along with reporting and alerts.

The foregoing is intended only to illustrate the present technical field and background art and should not be taken as a limitation or disavowal of the scope of the disclosure.

### BRIEF SUMMARY

The present disclosure is an improved apparatus, system and methods for monitoring static and digital displays and display panels, by recording the display using multiple cameras, providing remote monitoring, operational reporting and alerts, along with POP services, for operators, including a web-based or application-based monitoring, alerting and reporting system. For accuracy purposes, the system relies on a camera to record the actual advertisement being displayed on the billboard, while a second camera (or other sensor) is used to record a unique identification mark that pertains to the particular advertisement being displayed, whether the advertisement is an image, a video or even text. By recording both the actual video and the identification mark, the system can accurately monitor and report on the various advertisements being displayed, including the time and length of display.

The present disclosure relates to a POP system that is independent from the digital display's internal media player and has the ability to prove that particular content was actually displayed on the screen, not just an output ostensibly displayed on the screen. To do so, the present disclosure incorporates a digital display monitoring system featuring a two camera system and a control box. The two cameras are housed in designs that can be attached easily to the screen or monitor frame to obtain actual video as it is displayed.

The present disclosure is an improved apparatus and system for monitoring static and digital displays and display panels incorporating a first camera located and positioned to capture an identifier, such as a matrix code, unique to each piece of content, whether the content is static, a movie/animated advertisement, or even a public transit template, for example, the CTA Tracker. The code is relatively small, compared to the size of the display screen, for example, approximately 0.5″ by 0.5″, and placement of the code is a one-step process done by a content manager.

The present disclosure is also an improved apparatus and system for monitoring static and digital displays and display panels incorporating a second camera that is located and positioned to capture some of or all of the actual display screen, thereby expanding the authenticity and accuracy of the POP reports, as well as improving monitoring and alerting of any display failures. The second camera captures images of the screen at reasonable intervals, for example every 3-5 seconds, thereby providing the necessary redundancy to POP reports.

The present disclosure further provides an improved apparatus and system for monitoring static and digital displays and display panels incorporating a control box, which contains, among other components, microprocessors, wireless communications components, such as Wi-Fi, Bluetooth, etc., and a back-up battery for providing hours of power during any power interruptions. The control box is configured to easily fit into existing digital displays though the components and can alternatively be mounted within a digital display housing.

As a non-limiting example, the instant disclosure relates to an apparatus and system for monitoring static and digital billboards placed and located on the side of an interstate highway or other pedestrian and/or high traffic area. The billboards would incorporate an embodiment of the present disclosure and would monitor a unique identification mark along with the actual billboard display, and provide reporting functions to the system user. The reporting functions would include details of the operation of the billboard and alerts for faulty operation, along with POP services. The communications pertaining to the billboard can be implemented through a web-based or application-based monitoring, alerting and reporting system.

As another, non-limiting example, the present disclosure relates to an apparatus and system for monitoring static and digital displays and display panels, such as those located in airport terminals and the like, whether in the gate area or another area in the terminal, so that when a display fails, an embodiment of the present disclosure could provide almost immediate feedback of the failure to the operators of the system.

As such, it is an objective of the present disclosure to be capable of compiling reports various POP reports, such as advertisement run-times, frequency, and failure, as well as monitoring the performance of the digital display and alerting operators of any failures. All of the reports can be accessed in real-time, based on the capability of system that gathers data every few minutes. The software architecture is stable, flexible, efficient, and upgradeable, with the potential for image identification through computer vision.

It is another objective of the present disclosure to be configured with billboard and/or screen monitoring, alerting and reporting, for those in the retail environment currently utilizing content management systems that monitor the media players, not the actual display. The present invention can be incorporated to monitor, for example, actual in-store displays, to provide POP reports and alerts when those in-store displays are not properly displaying the media intended for customer viewing.

Additional objectives and advantages of the present disclosure will become apparent to one having ordinary skill in the art after reading the specification in light of the drawing figures, however, the spirit and scope of the present invention should not be limited to the description of the embodiments contained herein.

### BRIEF DESCRIPTION OF THE DRAWINGS

FIG. 1 is a functional block diagram of an exemplary embodiment of a digital display monitor and reporting system in accordance with the present disclosure.

FIG. 2 is a perspective view of an exemplary embodiment of a control box for a digital display monitor and reporting system in accordance with the present disclosure.

FIG. 3 is a hardware diagram of an exemplary embodiment of an identification code camera box for a digital display monitor and reporting system in accordance with the present disclosure.

FIG. 4 is a perspective view of an exemplary embodiment of an identification code camera box for a digital display monitor and reporting system in accordance with the present disclosure.

FIG. 5 is a hardware diagram of an exemplary embodiment of a screen camera box for a digital display monitor and reporting system in accordance with the present disclosure.

FIG. 6 is a perspective view of an exemplary embodiment of a screen camera box for a digital display monitor and reporting system in accordance with the present disclosure.

FIG. 7 is a flow chart diagram of an exemplary embodiment of a digital display monitoring reporting system in accordance with the present disclosure.

FIG. 8 is a flow chart diagram of an exemplary embodiment of a digital display reporting system in accordance with the present disclosure.

### DETAILED DESCRIPTION

As stated herein, the objective of the present disclosure is to provide an improved apparatus, system and methods for the monitoring of and reporting on digital displays, and in particular, the present invention is an apparatus, system and methods for monitoring static and digital displays and display panels, such as billboards, by recording the display, and providing for operators and users remote monitoring, operational reporting and alerts, along with proof of performance (POP) services, all through a web-based or application-based monitoring, alerting and reporting system.

The present disclosure further relates to such a POP system that is independent from the digital display's internal media player and proves content was actually displayed on the screen, not just an output ostensibly displayed on the screen. In doing so, the present disclosure incorporates a digital display monitoring system featuring a two camera system and a control box. The two cameras are housed in housing designs that can be attached easily to the screen or monitor frame to obtain actual video as it is displayed.

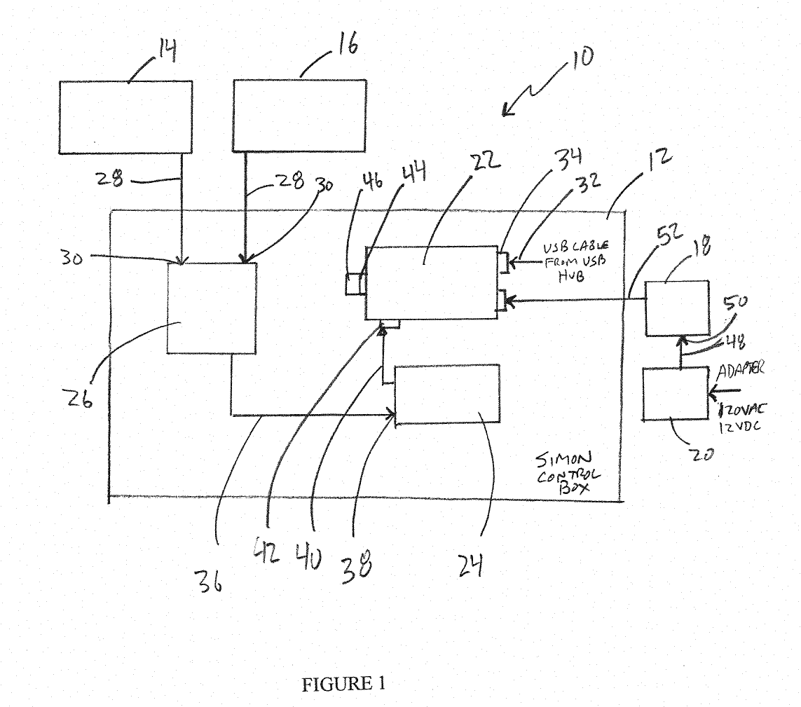

Referring to the drawings, wherein like reference numerals refer to the same or similar features in the various views, FIG. 1 is a functional block diagram of an exemplary embodiment of a digital display monitor and reporting system 10 in accordance with the present disclosure. In particular, FIG. 1 shows a block diagram of a control box 12, a first camera or code camera 14, a second camera or screen content camera 16, a cellular module 18 and a battery backup 20.

The control box 12 comprises a computer 22, a control box battery backup 24 and a USB hub 26 for connecting to the code camera 14 and the screen content camera 16. The code camera 14 and the screen content camera 16 are connected to the USB hub 26 via USB cables 28, which are connected to the USB hub 26 at the USB connectors 30.

The USB hub 26 also connects to the computer 22 through a USB cable 32 at the USB connector 34. The USB hub 26 also connects to the control box battery backup 24 through a USB cable 36 at a USB connector 38. The control box battery backup 24 also connects to the computer 22 through a USB cable 40 to the power connector 42 on the computer 22. The power connector 42 is also a USB connector.

The computer 22 also contains an SD card reader 44, which can accept an SD card 46. The battery backup 20 for the cellular module 18 is connected to the cellular module 18 through a USB cable 48 at a USB connector 50. While the cellular module 18 is connected to the computer 22 through a Local Area Network (LAN) cable 52 at a LAN connector 54.

The components disclosed herein can be replaced by other components that would provide the same functionality as understood by one having ordinary skill in the art. For example, although most of the connections between the components as disclosed herein are through USB cables and connectors, any other type of connector and cable will suffice.

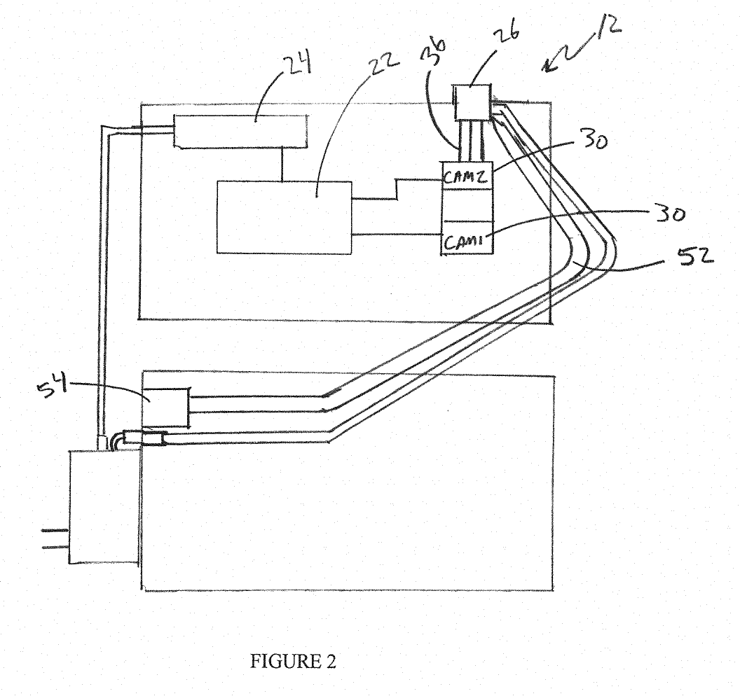

FIG. 2 shows a perspective view of an actual exemplary embodiment of a control box 12 for the digital display monitor and reporting system 10 in accordance with the present disclosure. The control box 12 houses the computer or processor 22, the USB hub 26, which comprises the associated USB connectors 30 and the battery backup 24, connected to the USB hub 26 through the USB cable 36. The cellular module 18 (not shown in FIG. 2) will connect to the computer 22 through the LAN connector 54 and the LAN cable 52.

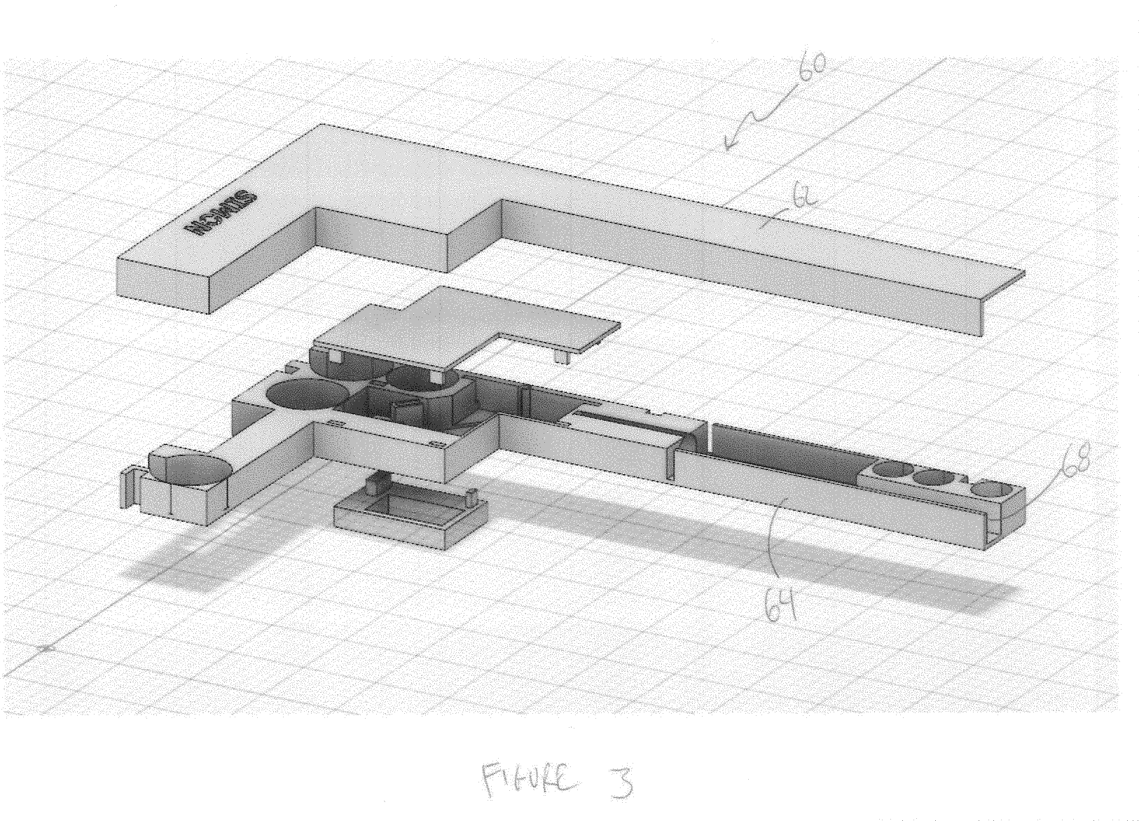

FIG. 3 shows a hardware diagram of an exemplary embodiment of an identification code housing 60 for the identification code camera 14 for the digital display monitor and reporting system 10 in accordance with the present disclosure. The identification code camera housing comprises an identification code camera housing cover 62, which will be used to cover the actual identification code camera 14, the identification code camera housing base 64 and the identification code camera housing insert 66. The identification code camera housing base 64 is configured to securely hold the identification code camera 14 along with containing a USB cable recess 68 for the USB cable 30 connecting the identification code camera 14 to the USB hub 26.

The identification code camera housing insert 66 fits securely between the identification code camera housing cover 62 and the identification code camera housing base 64 to assist in securely holding the identification code camera 14 in the correct position. The identification code camera housing 60 is attached with magnets or screws, if the latter is allowed.

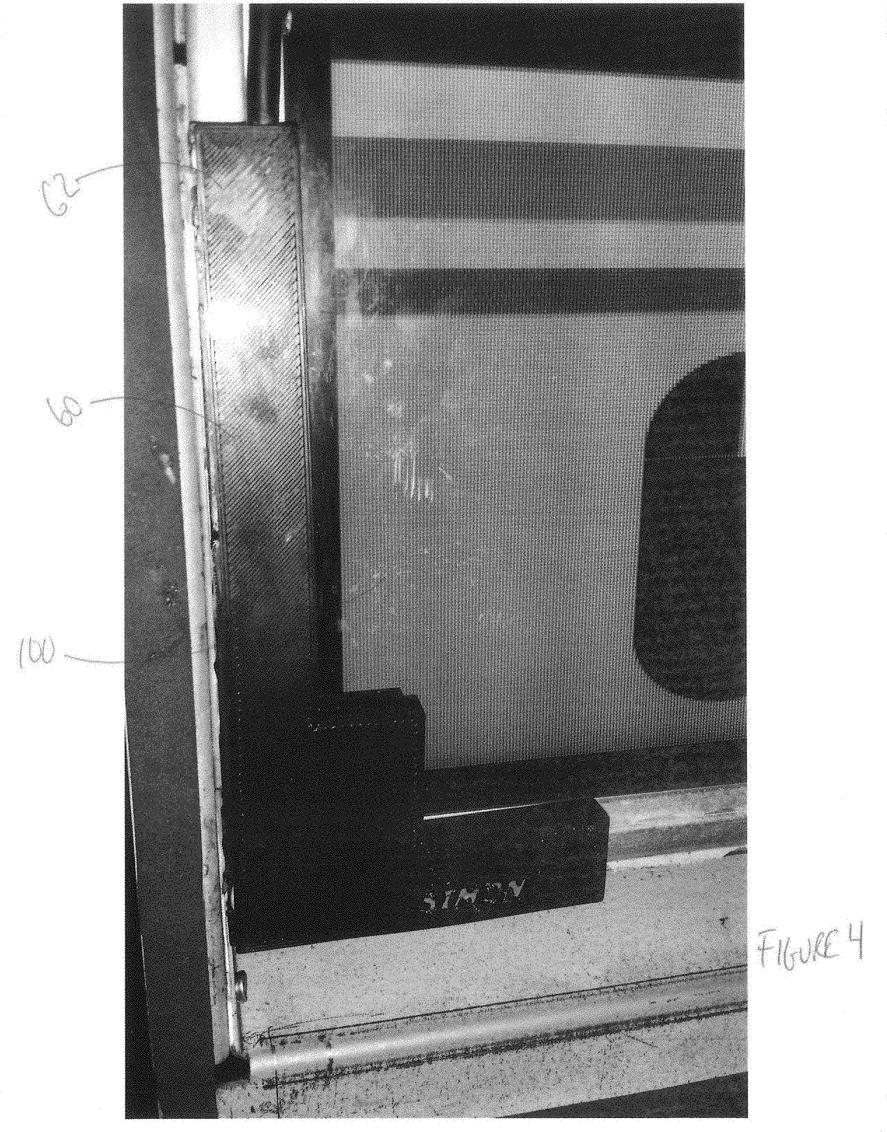

FIG. 4 shows a perspective view of an exemplary embodiment of an identification code camera housing 60 for a digital display monitor and reporting system 10 in accordance with the present disclosure, located in position with respect to a digital display monitor 100. The identification code camera housing cover 62 covers the remaining components of the identification code camera housing 60. In particular, the identification code camera 14 is placed and located against the portion of the digital display monitor 100, such as a billboard, that displays the unique identification code (not shown). In this example, the identification code camera housing 60 is located in the bottom left of the digital display monitor 100, if the observer was facing the monitor 100.

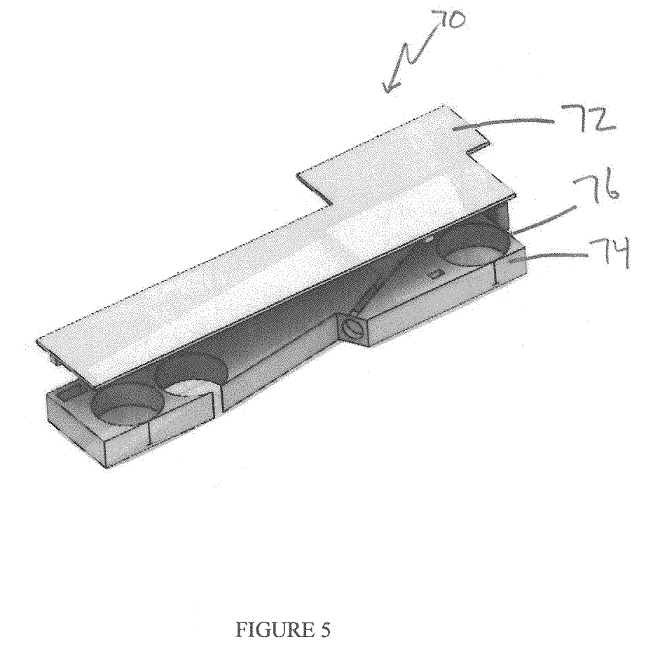

FIG. 5 shows a hardware diagram of an exemplary embodiment of a screen camera housing 70 for the screen camera 16 for a digital display monitor and reporting system 10 in accordance with the present disclosure. The screen camera housing 70 comprises a screen camera housing cover 72, which will be used to cover the actual screen camera 16 and the screen camera housing base 74. The screen camera housing base 74 is configured to securely hold the screen camera 16 along with containing a USB cable recess 76 for the USB cable 30 connecting the identification code camera 16 to the USB hub 26.

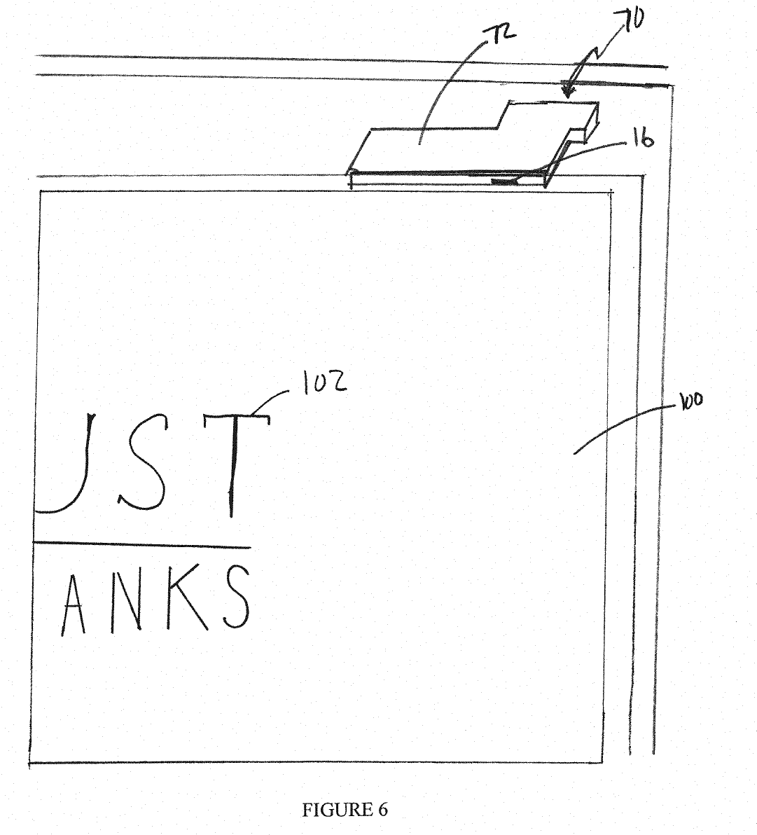

FIG. 6 shows a perspective view of an exemplary embodiment of a screen camera housing 70 for a digital display monitor and reporting system 10 in accordance with the present disclosure, located in position with respect to a digital display monitor 100. The screen camera housing cover 72 covers the remaining components of the screen camera housing 70. In particular, the screen camera 16 is placed and located in a position that it can record and capture the actual screen portion of the digital display monitor 100, such as a billboard, that displays the advertisement or message 102. In this example, the screen camera housing 70 is located in the upper right of the digital display monitor 100, if the observer was facing the monitor 100. The screen camera housing 70 is attached using magnets or screws, if the latter is allowed.

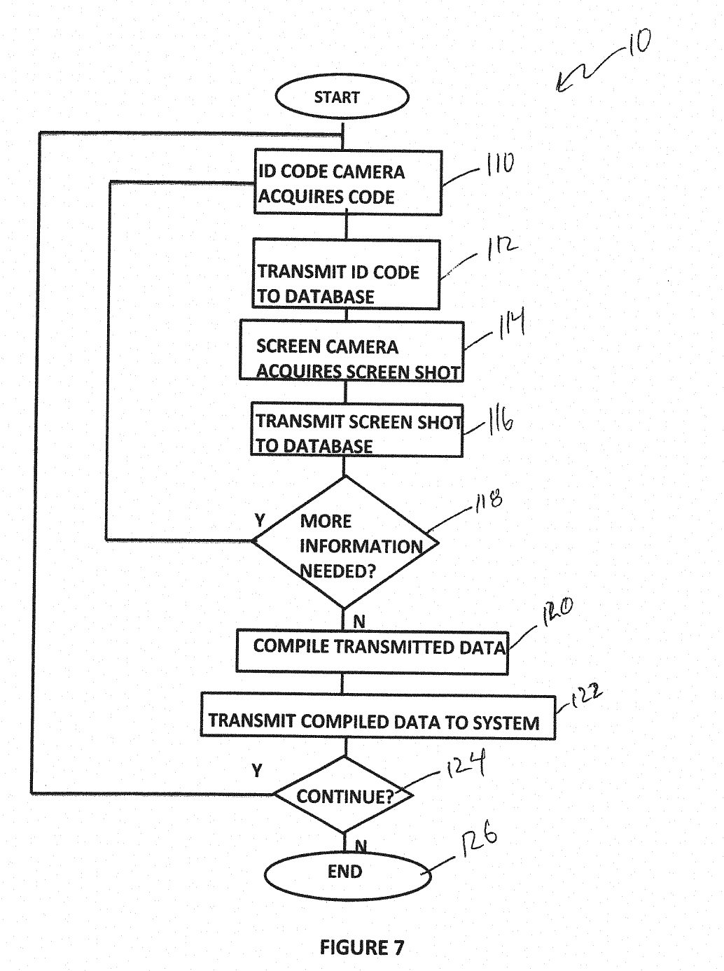

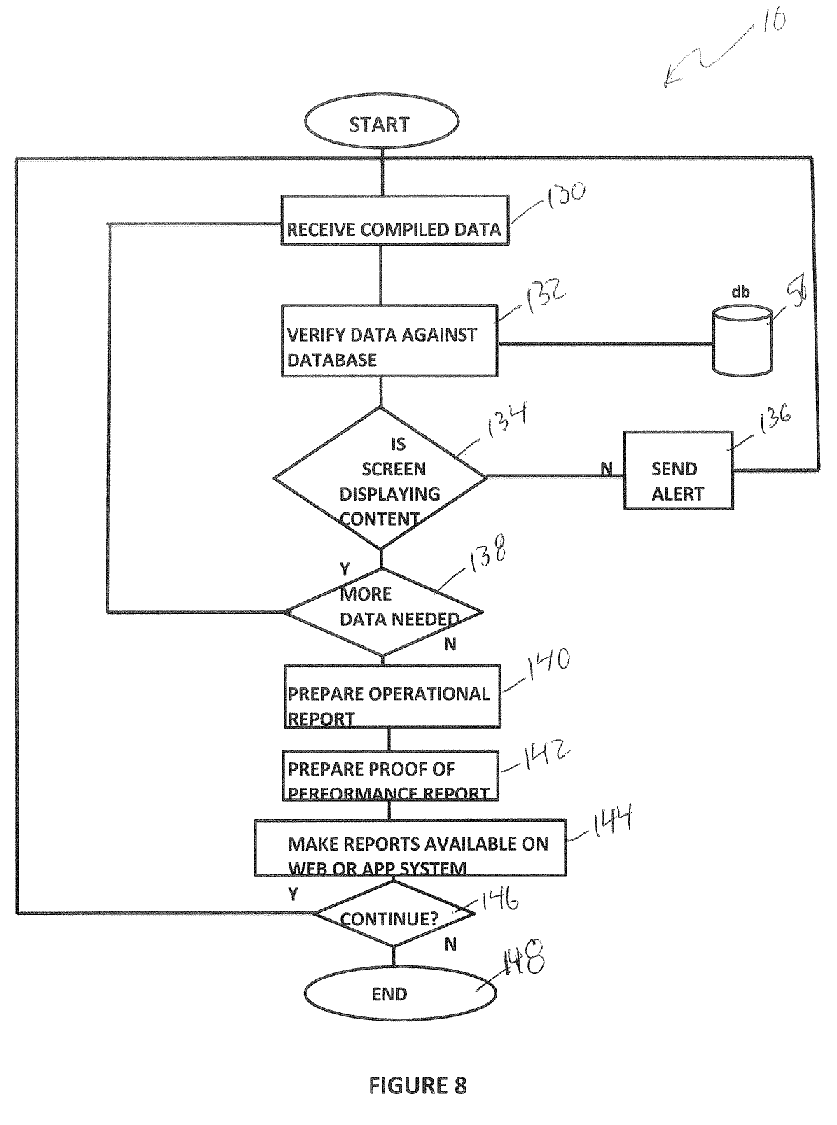

FIG. 7 shows a flow chart of an exemplary embodiment of the preferred disclosure. As set forth in detail herein, the digital display monitor and reporting system 10 comprises, inter alia, a control box 12, an ID code camera 14 and a screen content camera 16, along with additional components. The control box 12 comprises a computer 22 which includes a memory for storing software and data, with or without a separate database 56 (shown in FIG. 8) for storing data captured by one or both cameras 14, 16, along with data for comparing to the captured data. The software stored in the computer 22 or in a memory that can be accessed by the computer 22 can be accessed and executed by the computer 22 to control the various components of the system 10. For example, the computer 22, based on the executable program, can determine the correct time for the ID code camera 14 to acquire the ID code on the display screen. The acquired code can then be checked against a code stored in the database 56, or transmitted for comparison to a remote location.

The example in FIG. 7 is the preferred embodiment of the digital display monitor and reporting system 10, however, one having ordinary skill in the art can understand alternative embodiments based on the example provided herein. In the example, the initial step 110 is for the ID code camera 14 to acquire the code on the actual screen. This is performed by the ID code camera 14 which is controlled by the computer 22 in the control system 12. Once the code is acquired 110 by the code camera 14, the acquired code is transmitted 112 to the database 56 for compiling and/or processing.

Next, the screen camera 16 acquires a picture 114 of a portion of the screen 100 or the entire screen 100, at that particular moment. This is performed by the screen camera 16 which is also controlled by the computer 22 in the control system 12. Once a portion or the entire screen 100 is acquired 114 by the screen camera 16, the acquired screen information is transmitted 116 to the database 56 for additional compiling and/or processing.

If additional code or screen information is needed 118 for compiling or processing, the system 10 begins again by instructing the ID code camera 14 and screen camera 16 to acquire more data and transmit that data to the database 56.

If the system 10 determined that enough data has been acquired 118, the system 10 can compile the data acquired 120. The acquired and compiled data is then transmitted to the system 122 for further processing as detailed in FIG. 8. Next, the system 10 determines if there is a need to continue 124 with the data acquisition and compilation of the data. If so, the system 10 starts again at the initial step 110. If not, the system 10 ends the process 126.

The example in FIG. 8 is also the preferred embodiment of the digital display monitor and reporting system 10 as that system 10 prepares reports and makes those reports available to the users of the system 10. However, as with FIG. 7 above, one having ordinary skill in the art can understand that alternative embodiments exist based on the example provided herein.

In the FIG. 8 example, in the initial step 130, the compiled data (from FIG. 7) is received. Next, that data is verified 132 against data previously entered into the database 56. The system 10 checks that the monitor is displaying content 134, and if not, an alert is sent 136, and the system 10 goes back to receive additional compiled data 130. If the monitor is displaying content 134, the system 10 checks to see if more data is needed 138 prior to preparing reports.

If additional data is needed 138, the system 10 goes back to receive additional compiled data 130. If no more data is needed 138, the system 10 prepares operational reports 140, then prepares proof of performance reports 142 and makes the reports available to users 144, either by website access, through an application, or in other ways understood by those having ordinary skill in the art. To the extent the system 10 determines that more compiled data is needed 146, the process begins again to receive compiled data 130. If no more compiled data is needed 146 the system 10 can stop the process 148. As detailed herein, the exemplary reporting functions include details of the operation of the billboard and alerts for faulty operation, along with POP services, and the communications to the users can be implemented through a web-based or application-based monitoring, alerting and reporting system.

Reference throughout the specification to “various embodiments,” “some embodiments,” “one embodiment,” or “an embodiment”, or the like, means that a particular feature, structure, or characteristic described in connection with the embodiment is included in at least one embodiment. Thus, appearances of the phrases “in various embodiments,” “in some embodiments,” “in one embodiment,” or “in an embodiment”, or the like, in places throughout the specification are not necessarily all referring to the same embodiment.

Further, the particular features, structures, or characteristics may be combined in any suitable manner in one or more embodiments. Thus, the particular features, structures, or characteristics illustrated or described in connection with one embodiment may be combined, in whole or in part, with the features structures, or characteristics of one or more other embodiments without limitation given that such combination is not illogical or non-functional. Although numerous embodiments of this invention have been described above with a certain degree of particularity, those skilled in the art could make numerous alterations to the disclosed embodiments without departing from the spirit or scope of this disclosure.

All directional references (e.g., plus, minus, upper, lower, upward, downward, left, right, leftward, rightward, top, bottom, above, below, vertical, horizontal, clockwise, and counterclockwise) are only used for identification purposes to aid the reader's understanding of the present disclosure, and do not create limitations, particularly as to the position, orientation, or use of the any aspect of the disclosure.

As used herein, the phrased “configured to,” “configured for,” and similar phrases indicate that the subject device, apparatus, or system is designed and/or constructed (e.g., through appropriate hardware, software, and/or components) to fulfill one or more specific object purposes, not that the subject device, apparatus, or system is merely capable of performing the object purpose. Joinder references (e.g., attached, coupled, connected, and the like) are to be construed broadly and may include intermediate members between a connection of elements and relative movement between elements. As such, joinder references do not necessarily infer that two elements are directly connected and in fixed relation to each other. It is intended that all matter contained in the above description or shown in the accompanying drawings shall be interpreted as illustrative only and not limiting. Changes in detail or structure may be made without departing from the spirit of the invention as defined in the appended claims.

Any patent, publication, or other disclosure material, in whole or in part, that is said to be incorporated by reference herein is incorporated herein only to the extent that the incorporated materials does not conflict with existing definitions, statements, or other disclosure material set forth in this disclosure. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

1. A system for monitoring static displays by recording the static display using multiple sensors and providing remote monitoring, operational reporting and alerts, along with proof of performance services, the system comprising:
a. a first sensor, said first sensor installed in a first location on a static display, said first location configured to allow said first sensor to record an advertisement being displayed on said static display;
b. a second sensor, said second sensor installed in a second location on said static display, said second location configured to allow said second sensor to record a unique identification mark, said unique identification mark pertaining to the said advertisement; and
c. a control box, said control box sized and configured to fit onto said static display, wherein said control box monitors the recording of said advertisement and said unique identification mark, and provides reporting functions pertaining to the advertisement being displayed.

2. The system for monitoring static displays of claim 1, further comprising an application to which the control box provides said reporting functions.

3. The system for monitoring static displays of claim 2, where the application is a web-based monitoring, alerting and reporting system.

4. The system for monitoring static displays of claim 2, where the application is an application-based, alerting and reporting system.

5. The system for monitoring static displays of claim 1, where said reporting functions include details of the operation of the static display, alerts for faulty operation, proof of performance.

6. The system for monitoring static displays of claim 1, where said first sensor is a first camera.

7. The system for monitoring static displays of claim 1, where said second sensor is a second camera.

8. The system for monitoring static displays of claim 1, where said static display is a billboard, a display panel, an in-store display or an airport terminal display.

9. The system for monitoring static displays of claim 1, where said advertisement is an image, a video or a text.

10. The system for monitoring static displays of claim 5, where said details of operation include the date, time, length of display of the advertisement, frequency and failures.

11. The system for monitoring static displays of claim 1, where said reporting functions are gathered intermittently.

12. The system for monitoring static displays of claim 11, where said reporting functions are gathered every few minutes.

13. The system for monitoring static displays of claim 11, where said reporting functions are gathered every few seconds.

14. The system for monitoring static displays of claim 1, where said reporting functions are provided in real time.

15. A method of monitoring static displays by recording the static display using multiple sensors and providing remote monitoring, operational reporting and alerts, along with proof of performance services, the steps of the method comprising:
a. installing a first sensor in a first location on a static display, said first location configured to allow said first sensor to record an advertisement being displayed on said static display;
b. installing a second sensor in a second location on said static display, said second location configured to allow said second sensor to record a unique identification mark, said unique identification mark pertaining to the said advertisement;
c. installing a control box, said control box sized and configured to fit onto said static display,
d. using the control box to monitor the recording of said advertisement and said unique identification mark;
e. using the control box to provide reporting functions pertaining to the advertisement being displayed.

16. The method of monitoring static displays of claim 15, further comprising an application to which the control box provides said reporting functions.

17. The method of monitoring static displays of claim 16, where the application is a web-based monitoring, alerting and reporting system.

18. The method of monitoring static displays of claim 16, where the application is an application-based, alerting and reporting system.

19. The method of monitoring static displays of claim 15, where said reporting functions include details of the operation of the static display, alerts for faulty operation, proof of performance.

20. The method of monitoring static displays of claim 19, where said details of operation include the date, time, length of display of the advertisement, frequency and failures.

21-40. (canceled)
